(19) United States
(12) Patent Application Publication
(10) Pub. No.: US 2010/0233926 A1
(43) Pub. Date: Sep. 16, 2010

(54) THERMALLY CONDUCTIVE ADHESIVES AND ADHESIVE TAPE USING THE SAME

(76) Inventors: Ju-Young Shin, Gyeonggi-do (KR); Sungpil Moon, Gyeonggi-do (KR); Daesung Ju, Seoul (KR)

Correspondence Address: 3M INNOVATIVE PROPERTIES COMPANY, PO BOX 33427, ST. PAUL, MN, 55133-3427, US

(21) Appl. No.: 12/740,113

(22) PCT Filed: Oct. 22, 2008
(86) PCT No.: PCT/US08/80733

§ 371 Date: Apr. 28, 2010

(30) Foreign Application Priority Data
Oct. 30, 2007 (KR) 10-2007-0109273

(51) Int. Cl. C09J 7/04; C09J 7/02; B05D 3/06; C08K 3/22; C08K 3/28; C08K 3/38; C08K 3/34; C08K 3/08

(52) U.S. Cl. 442/149; 428/343; 428/354; 427/516; 524/430; 524/428; 524/404; 524/443; 524/440; 524/556

(57) ABSTRACT

Disclosed is a thermally conductive adhesive comprising an adhesive polymer resin, a thermally conductive filler and a microhollow filler. The adhesive comprising a microhollow filler that can form a porous structure, in addition to a thermally conductive filler, can provide an adhesive tape having excellent thermal conductivity and adhesive properties.

### TECHNICAL FIELD

The present disclosure relates to a thermally conductive adhesive and an adhesive tape using the same.

### BACKGROUND

As technological development has been remarkable in recent years, particularly in the field of electronic industry, adhesion technology for electronic parts or devices have become very important. With regard to such adhesion technology, a thermally conductive adhesive comprising an adhesive polymer in which thermally conductive fillers are dispersed has been generally used for the adhesion of electronic parts or devices generating heat upon driving.

In general, a thermally conductive adhesive adheres to an electronic part or device on one surface thereof, while adhering to a heat sink on the other surface thereof. Such thermally conductive adhesives make it possible for electronic parts or devices to be adhered to each other, and serve to transfer the heat generated from the electronic parts or devices to the heat sink by way of thermally conductive fillers so as to discharge the heat to the exterior. Therefore, such adhesives are also referred to as heat transfer sheets. Meanwhile, a heat sink may further include a heat transfer pin in order to improve the heat transfer efficiency.

Conventional thermally conductive adhesives include those comprising metal oxides, metal nitrides or metal hydroxides and halogen-free organic flame retardants containing both phosphorus and nitrogen. Additionally, an adhesive for a heat transfer sheet comprising aluminum oxide as a thermally conductive filler and aluminum hydroxide as a flame retardant has been also disclosed.

When such adhesives are used as heat transfer sheets for electronic appliances, they show high heat discharge efficiency because they can transfer the heat rapidly to a heat sink. However, when heat generation occurs continuously or excessive heat generation occurs instantaneously, such adhesives reach a saturated degree of heat transfer due to their limit in heat transfer capacity, resulting in an increase in temperature of the adhesives and the electronic appliances. Additionally, when such adhesives have a large adhesion area, the adhesives may be in partial contact with a heat sink while leaving non-contact portions. In such non-contact portions, the heat generated from electronic parts or devices cannot be sufficiently discharged by way of the heat sink and local heat concentration occurs, resulting in generation of hot spots. Due to such thermal impacts, electronic parts or devices, and electronic appliances including the same may be degraded in quality.

Therefore, an attempt has been made to increase the amount of thermally conductive fillers in such adhesives so that local hot spot generation can be inhibited, or an excessive amount of heat generated instantaneously can be transferred effectively. However, use of an excessive amount of thermally conductive fillers results in degradation of workability during the preparation of the adhesives and a drop in adhesion of the adhesives.

### SUMMARY

Therefore, the present disclosure has been made in view of the above-mentioned problems. The inventors of the present disclosure have conducted many studies to develop an adhesive having high heat transfer efficiency to a heat sink and excellent adhesion sufficient to prevent the generation of a local hot spot.

As a result, the inventors of the present disclosure have found that when an adhesive comprises a microhollow filler formed of a plurality of air bubble-like particles independent from each other and having voids therein, in addition to thermally conductive fillers, the adhesive can have excellent adhesion while maintaining excellent thermal conductivity and flame resistance, due to its porous structure. The present disclosure is based on this finding.

According to an aspect of the present disclosure, there is provided a thermally conductive adhesive comprising an adhesive polymer resin, a thermally conductive filler and a microhollow filler.

According to another aspect of the present disclosure, there is provided an adhesive tape in the form of a sheet, the adhesive tape including the above thermally conductive adhesive applied on either surface or both surfaces of a substrate. There is also provided a method for producing the adhesive tape.

As used herein, the term “wettability” means a degree of spreading, adhesion or close contact of an adhesive onto a solid surface.

In other words, the term “wettability” refers to spreadability of a liquid or solid on a solid surface, and serves as an indicator of adhesion.

The adhesive according to the present disclosure is characterized by further comprising a microhollow filler in addition to an adhesive polymer resin and a thermally conductive filler.

In other words, the adhesive according to the present disclosure, which comprises a microhollow filler in an adhesive polymer resin, can have a porous structure formed therein. Due to the above porous structure, the adhesive has improved wettability and/or softness, and thus can show improved adhesion and can be in close contact with various surfaces. For example, the adhesive can be in close contact with electronic parts or devices having rough surfaces. Therefore, even when the adhesive occupies a large adhesion area, it is possible to prevent generation of local hot spots due to a reduced non-contact portion between the adhesive and a heat sink. Further, the adhesive according to the present disclosure may be further provided with flame resistance, thermal conductivity or electron wave-shielding properties depending on the components present on the surface of the microhollow filler.

Additionally, because the adhesive according to the present disclosure comprises a thermally conductive filler with excellent heat conduction efficiency in the adhesive polymer resin, it is possible to transfer a great amount of heat generated in electronic appliances rapidly to a heat sink and to discharge the heat effectively.

The thermally conductive adhesive according to the present disclosure has a heat conductivity of about 0.35 to 0.8 W/mK and a wettability of at least about 50%, and thus provides an improvement in heat conductivity and wettability as compared to conventional adhesives.

### BRIEF DESCRIPTION OF THE DRAWINGS

The foregoing and other objects, features and advantages of the present disclosure will become more apparent from the following detailed description when taken in conjunction with the accompanying drawings in which:

FIG. 1 is a schematic view showing the adhesive tape obtained from Example 1 according to the present disclosure;

FIG. 2 is a schematic view showing the conventional adhesive tape obtained from Comparative Example 1;

FIG. 3a is a photographic view showing the wettability of the adhesive tape according to Comparative Example 1; and

FIG. 3b is a photographic view showing the wettability of the adhesive tape according to Example 1, wherein the dark portion shows that adhesion is made between the substrate and the corresponding adhesive tape.

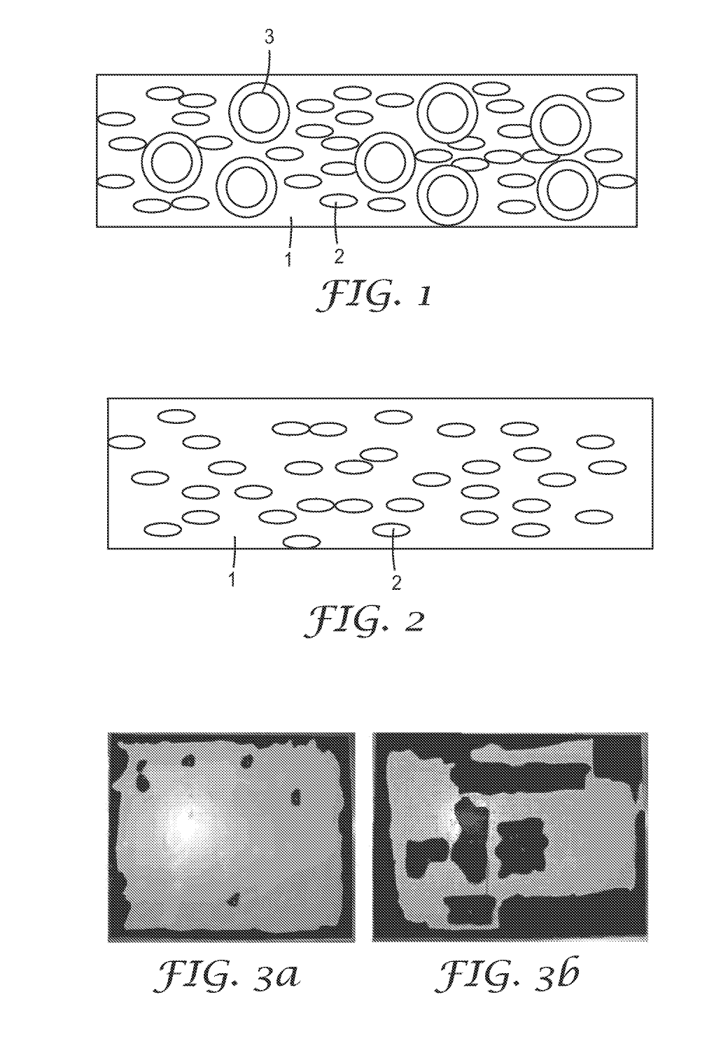

### DETAILED DESCRIPTION

Hereinafter, the present disclosure will be explained in more detail.

There is no particular limitation in the adhesive polymer resin that may be used in the present disclosure. According to a preferred embodiment of the present disclosure, the adhesive polymer resin includes an acrylic polymer. There is no particular limitation in the acrylic polymer resin and any acrylic resin known as an adhesive to those skilled in the art may be used.

Particular examples of the acrylic polymer resin include copolymers obtained via copolymerization of a C1 to C12 alkyl(meth)acrylate monomer with a polar monomer copolymerizable with the alkyl(meth)acrylate monomer.

Particular examples of the C1 to C12 alkyl (meth)acrylate monomer include, but are not limited to: butyl(meth)acrylate, hexyl(meth)acrylate, n-octyl(meth)acrylate, isooctyl(meth)acrylate, 2-ethylhexyl(meth)acrylate, isononyl(meth)acrylate, or the like.

Particular examples of the polar monomer copolymerizable with the (meth)acrylate monomer include carboxyl group-containing monomers, such as (meth)acrylic acid, maleic acid or fumaric acid, or nitrogen-containing monomers, such as acrylamide, N-vinyl pyrrolidone or N-vinyl caprolactam, or the like. Such polar monomers function to impart a cohesive force to the adhesive and to improve the adhesion.

In the adhesive polymer resin, there is no particular limitation in the ratio of the (meth)acrylate monomer to the polar monomer. Generally, the (meth)acrylate monomer and the polar monomer may be used in a weight ratio of 99 to 80:1 to 20. The above range allows the acrylic resin to exhibit an adhesion required as an adhesive.

Meanwhile, as used herein, the term “microhollow filler” means a filler formed of bubble-like particles having voids therein, each particle having an independent air bubble.

Such bubble-like microhollow fillers can form a porous structure in the adhesive. Therefore, the adhesive according to the present disclosure shows increased softness and/or wettability, resulting in an improvement in adhesion or close contact properties when used in electronic parts. Additionally, because the microhollow filler uses a flame resistance material, such as aluminum oxide, silicon oxide or a mixture thereof, as a surface component, it also serves to prevent a fire accident caused by a high temperature.

Non-limiting examples of the microhollow filler include ultralow-weight microhollow spheres made of igneous rocks, microglass bubbles formed by processing and synthesizing glass, and resin bubbles, such as epoxy or polycarbonate resin bubbles. According to a preferred embodiment of the present disclosure, ceramic bubbles may be used as the microhollow filler.

Surface components of such microhollow fillers may be selected from flame resistant materials, thermally conductive materials, electron wave-shielding materials, or the like, depending on desired functions. Non-limiting examples of the surface components of the microhollow fillers include aluminum oxide, silicon oxide or a mixture thereof. When using such components, the microhollow filler serves to prevent a fire accident caused by a high temperature, and has high heat transfer efficiency and excellent thermal conductivity and flame resistance.

The microhollow filler preferably has a particle diameter of about 20 to 500 μm. When using a microhollow filler having a particle diameter of less than 20 μm, the adhesive cannot provide a desired degree of softness or wettability due to an excessively small pore size even though the microhollow filler forms a porous structure in an adhesive polymer resin. On the other hand, when using a microhollow filler having a large diameter of greater than 500 μm, the resultant adhesive has a reduced adhesion area to electronic parts due to an excessively large pore size. In the latter case, the electronic parts cannot maintain adhesion to each other, and the heat generated upon the driving of such electronic parts cannot be effectively transferred to a heat sink.

In addition, in the adhesive according to the present disclosure, the microhollow filler may be used in an amount of about 10 to 200 parts by weight based on 100 parts by weight of the adhesive polymer resin. When the microhollow filler is used in an amount of less than 10 parts by weight, it is not possible to form a porous structure providing a desired degree of wettability. On the other hand, when the microhollow filler is used in an amount of greater than 200 parts by weight, the adhesive has an excessive amount of porous structures formed therein, thereby providing a reduced heat transfer rate.

Particular examples of the thermally conductive filler that may be used in the present disclosure include metal oxides, metal hydroxides, metal nitrides, metal carbides, metal borides, carbon fibers, graphite, silicon carbide, sendust (Al 6 wt %-Si 9 wt %-Fe 85 wt %). Aluminum oxide, aluminum nitride and aluminum hydroxide are preferred.

The thermally conductive filler preferably has a particle diameter of about 1 to 100 μm. If the thermally conductive filler has a particle diameter of less than 1 μm, the resultant adhesive may show an increased slurry viscosity during a mixing step with the adhesive polymer resin in a process for preparing the adhesive, resulting in a drop in processability. Therefore, when producing an adhesive sheet by using the adhesive according to the present disclosure, the adhesive may show poor coatability on a substrate. Additionally, if the thermally conductive filler has a particle diameter of greater than 100 μm, the resultant adhesive may have excellent heat transfer property but the thermally conductive filler may precipitate during a mixing step with the adhesive polymer resin or a coating layer curing step.

Additionally, in the adhesive according to a preferred embodiment of the present disclosure, the thermally conductive filler may be used in an amount of about 10 to 200 parts by weight based on 100 parts by weight of the adhesive polymer resin. If the thermally conductive filler is used in an amount of less than 10 parts by weight, the resultant adhesive may provided a reduced heat transfer rate. On the other hand, if the thermally conductive filler is used in an amount of greater than 200 parts by weight, the resultant adhesive may show an excessively increased hardness, resulting in degradation of the softness of the adhesive and a drop in close contact properties of the adhesive.

The adhesive according to the present disclosure may be prepared according to a conventional process for preparing an adhesive.

For example, materials for the adhesive polymer resin are mixed with the microhollow filler and the thermally conductive filler, and the materials for the polymer resin are subjected to polymerization and then are cured to provide the adhesive. If necessary, the adhesive may further comprise other additives.

More preferably, in order to facilitate mixing of the microhollow filler with the thermally conductive filler and other additives, the materials for the adhesive polymer resin are prepolymerized to provide syrup, and then the microhollow filler, the thermally conductive filler and other additives are added thereto and the resultant mixture is agitated and cured to provide the adhesive.

In order to provide an adhesive tape, the syrup-like materials for the adhesive polymer resin are mixed with the microhollow filler, the thermally conductive filler and other additives, and the resultant mixture is agitated. Then, the mixture is applied and coated onto a thin substrate, and the coating layer is cured.

Hereinafter, one embodiment of the method for preparing an adhesive tape by using the adhesive according to the present disclosure will be described in more detail.

A C1 to C12 (meth)acrylate monomer and a polar monomer copolymerizable with the monomer are subjected to partial polymerization, preferably by way of heating, to provide syrup having a viscosity of about 1,000 to 20,000. To the syrup, the above-mentioned thermally conductive filler and the microhollow filler (e.g. Al(OH)₃ as a thermally conductive filler and ceramic bubbles as a microhollow filler) are added optionally with a crosslinking agent, a photoinitiator, an antioxidant, etc. and then the above materials are mixed and agitated to provide a mixture. Then, the mixture is applied onto a substrate and is subjected to photopolymerization and crosslinking under the irradiation of light (UV rays) so as to obtain an adhesive tape. The adhesive according to the present disclosure may be used for producing a single-side or double-side tape by applying it onto either surface or both surfaces of a substrate.

The crosslinking agent may be used in a controlled amount to modify the adhesive properties of the adhesive. Preferably, the crosslinking agent may be used in an amount of about 0.05 to 2 parts by weight based on 100 parts by weight of the adhesive polymer resin. Particular examples of the crosslinking agent that may be used for preparing the adhesive according to the present disclosure include, but are not limited to: multi-functional acrylates, such as crosslinkable monomers including 1,6-hexanediol diacrylate, trimethylolpropane triacrylate, pentaerythrithol triacrylate, 1,2-ethylene glycol diacrylate, 1,12-dodecanediol acrylate, or the like.

The photoinitiator may be used in a controlled amount so as to modify the polymerization degree of the adhesive. Preferably, the photoinitiator may be used in an amount of about 0.01 to 2 parts by weight based on 100 parts by weight of the adhesive polymer resin. Particular examples of the photoinitiator that may be used in the present disclosure include, but are not limited to: 2,4,6-trimethylbenzoyl diphenylphosphine oxide, bis(2,4,6-trimethylbenzoyl)phenylphosphine oxide, α,α-methoxy-α-hydroxyacetophenone, 2-benzoyl-2-(dimethylamino)-1-[4-(4-morphonyl)phenyl]-1-butanone, 2,2-dimethoxy 2-phenylacetophenone, or the like.

The antioxidant may be used in a controlled amount so as to modify the polymerization degree of the adhesive. Preferably, the antioxidant may be used in an amount of about 0.01 to 2 parts by weight based on 100 parts by weight of the adhesive polymer resin. Particular examples of the antioxidant that may be used in the present disclosure include, but are not limited to: octadecyl 3,5-dibutyl-4-hydroxyhydrocinnamate, tetrakis[methylene(3,5-di-t-butyl-4-hydroxyhydrocinnamate)]methane, thiodiethylene bis[3-(3,5-di-t-butyl-4-hydroxyphenyl)propionate], or the like.

The substrates that may be used in the tape according to the present disclosure include plastics, paper, non-woven webs, or the like. Polyethylene terephthalate (PET) films are preferred. Although there is no particular limitation in the thickness of the substrate, the substrate may have a thickness of 1 μm to 1 mm, considering the thermal conductivity and coatability of the adhesive. The substrate may have a thickness that varies with the particular use of the adhesive tape.

Although there is no particular limitation in the thickness of the adhesive tape, the adhesive tape generally has a thickness of 50 μm to 2 mm. When the adhesive tape has a thickness of less than 50 μm, the adhesive sheet may provide a large amount of non-contact areas particularly on an adherent having a large surface area, resulting in a reduced contact surface for carrying out heat transfer. Thus, it is not possible to accomplish sufficient heat transfer between a heat emitting body and a heat sink. On the other hand, when the adhesive tape has a thickness of greater than 2 mm, the adhesive tape shows a low heat transfer rate and requires a long period of time to accomplish heat transfer.

The adhesive according to the present disclosure may further comprise other additives, such as a pigment, an anti-oxidant, a UV stabilizer, a dispersant, a defoaming agent, a thickening agent, a plasticizer, a tackifying resin, a silane coupling agent, a foaming agent, or the like.

The adhesive according to the present disclosure, which has excellent adhesive properties and thermal conductivity as described above, may be useful not only for transferring the heat generated from a heat emitting body to a heat sink in an electronic appliance, such as a plasma display panel, requiring a relatively stringent standard in terms of heat transfer properties, but also for supporting the heat emitting body and the heat sink.

Reference will now be made in detail to the preferred embodiments of the present disclosure. It is to be understood that the following examples are illustrative only and the present disclosure is not limited thereto.

### Example 1

First, 94 parts by weight of 2-ethylhexyl acrylate (all parts by weight recited herein are based on 100 parts by weight of an acrylic polymer resin) and 6 parts by weight of acrylic acid as a polar monomer were partially polymerized in a 1 L glass reactor by way of heating to provide syrup having a viscosity of 2000 cPs.

Then, 0.29 parts by weight of α,α-methoxy-α-hydroxyacetophenone as a photoinitiator, 0.2 parts by weight of 1,6-hexanediol diacrylate (HDDA) as a crosslinking agent and 0.3 parts by weight of octadecyl 3,5-dibutyl-4-hydroxyhydrocinnamate as an antioxidant were mixed with the above syrup and the resultant mixture was agitated thoroughly. To the mixture, 100 parts by weight of a thermally conductive filler, aluminum hydroxide [Al(OH)₃] having a particle diameter of 20 μm, and 20 parts by weight of a microhollow filler, ceramic bubbles having a particle diameter of 50 μm were added, and the resultant mixture was agitated to a sufficiently homogeneous state.

The mixture was debubbled under reduced pressure by using a vacuum pump, and was coated onto a polyester release film to a thickness of 1 mm via a knife coating process. At this time, the coating layer was covered with a polyester film so as to protect it from being in contact with oxygen. Then, UV irradiation was performed for 5 minutes by using a metal halide UV lamp to provide an adhesive tape.

### Comparative Example 1

An adhesive tape was provided in the same manner as described in Example 1, except that the microhollow filler was not used.

The adhesive tapes according to Examples 1 and Comparative Example 1 were measured for their thermal conductivity and wettability.

After the measurement, the adhesive tape according to Example 1 showed a slightly reduced thermal conductivity as compared to the conventional adhesive tape comprising no microhollow filler according to Comparative Example 1, but provided excellent wettability characteristics as could be seen by a wettability level of 54% (see the following Table 1 and FIG. 3). Therefore, it can be seen that the adhesive tape according to the present disclosure has excellent wettability, i.e. adhesion while maintaining excellent thermal conductivity.

TABLE 1

| | Thermal conductivity | |
|---|---|---|
| | (W/mK) | Wettability (%) |
| Ex. 1 | 0.4440 | 54 |
| Comp. Ex. 1 | 0.5078 | 20 |

As can be seen from the foregoing, the adhesive comprising a microhollow filler that can form a porous structure, in addition to a thermally conductive filler, according to the present disclosure can provide an adhesive tape having excellent thermal conductivity and adhesive properties.

Although several preferred embodiments of the present disclosure have been described for illustrative purposes, those skilled in the art will appreciate that various modifications, additions and substitutions are possible, without departing from the scope and spirit of the disclosure as disclosed in the accompanying claims.

1. A thermally conductive adhesive comprising an adhesive polymer resin, a thermally conductive filler and a microhollow filler.

2. A thermally conductive adhesive as claimed in claim 1, which has a thermal conductivity of about 0.3 to 0.8 W/mK and a wettability of at least 50%.

3. A thermally conductive adhesive as claimed in claim 1, wherein the microhollow filler includes bubble-like particles having voids therein.

4. A thermally conductive adhesive as claimed in claim 1, wherein the microhollow filler is selected from the group consisting of aluminum oxide, silicon oxide and a mixture thereof.

5. A thermally conductive adhesive as claimed in claim 1, wherein the microhollow filler includes ceramic bubbles.

6. A thermally conductive adhesive as claimed in claim 1, wherein the microhollow filler is used in an amount of about 10 to 200 parts by weight based on 100 parts by weight of the adhesive polymer resin.

7. A thermally conductive adhesive as claimed in claim 1, wherein the microhollow filler has a particle diameter of about 20 to 500 μm.

8. A thermally conductive adhesive as claimed in claim 1, wherein the thermally conductive filler is used in an amount of about 10 to 200 parts by weight based on 100 parts by weight of the adhesive polymer resin.

9. A thermally conductive adhesive as claimed in claim 1, wherein the thermally conductive filler has a particle diameter of about 1 to 100 μm.

10. A thermally conductive adhesive as claimed in claim 1, wherein the thermally conductive filler is selected from the group consisting of metal oxides, metal hydroxides, metal nitrides, metal borides, carbon fibers, graphite, silicon carbide and sendust.

11. A thermally conductive adhesive as claimed in claim 1, wherein the adhesive polymer resin is an acrylic polymer resin.

12. A thermally conductive adhesive as claimed in claim 11, wherein the acrylic polymer resin is a polymer resin obtained via copolymerization with a C1 to C12 alkyl(meth)acrylate monomer with a polar monomer copolymerizable with the (meth)acrylate monomer.

13. An adhesive tape obtained by applying the thermally conductive adhesive as defined in any one of claims 1 to 12 onto either surface or both surfaces of a substrate.

14. An adhesive tape as claimed in claim 13, wherein the substrate is selected from the group consisting of plastics, paper and non-woven webs.

15. A method for preparing an adhesive tape, which comprises the steps of:
(i) carrying out partial polymerization of an acrylic monomer with a polar monomer copolymerizable with the acrylic monomer to provide syrup;
(ii) adding a thermally conductive filler and a microhollow filler to the syrup and mixing and agitating the materials to provide a mixture;
(iii) applying the mixture onto either surface or both surfaces of a substrate; and
(iv) subjecting the mixture to light irradiation to perform polymerization and crosslinking

16. A method for preparing an adhesive tape as claimed in claim 15, wherein the syrup in step (i) has a viscosity of about 1000 to 20,000 cPs.

17. A method for preparing an adhesive tape as claimed in claim 15, wherein the microhollow filler includes bubble-like particles having voids therein.

18. A method for preparing an adhesive tape as claimed in claim 15, wherein the microhollow filler is selected from the group consisting of aluminum oxide, silicon oxide or a mixture thereof.
